(19) United States
(12) Patent Application Publication
(10) Pub. No.: US 2026/0153661 A1
(43) Pub. Date: Jun. 4, 2026

(54) DEPOLARIZATION COMPENSATOR AND OPTICAL SYSTEM

(71) Applicant: TRUMPF Lasersystems for Semiconductor Manufacturing SE, Ditzingen (DE)

(72) Inventor: Stefan Piehler, Stuttgart (DE)

(21) Appl. No.: 19/454,448

(22) Filed: Jan. 21, 2026

Related U.S. Application Data
(63) Continuation of application No. PCT/EP2024/070154, filed on Jul. 16, 2024.

(30) Foreign Application Priority Data
Jul. 26, 2023 (DE) 10 2023 119 826.2

(51) Int. Cl. G02B 5/30

(52) U.S. Cl. CPC G02B 5/3025

(57) ABSTRACT

A depolarization compensator for at least partial compensation of a location-dependent variation of a polarization of a laser beam includes a first compensation component comprising a birefringent material, and having a planar beam entry surface for entry of the laser beam and a beam exit surface for exit of the laser beam. A thickness of the first compensation component between the beam entry surface and the beam exit surface varies in a location-dependent manner in order to at least partially compensate for the location-dependent variation of the polarization of the laser beam. The depolarization compensator further includes a second compensation component for at least partial compensation of a light-refractive effect of the first compensation component on the laser beam. The second compensation component has no birefringent effect on the laser beam.

### CROSS REFERENCE TO RELATED APPLICATIONS

This application is a continuation of International Application No. PCT/EP2024/070154 (WO 2025/021594 A1), filed on Jul. 16, 2024, and claims benefit to German Patent Application No. DE 10 2023 119 826.2, filed on Jul. 26, 2023. The aforementioned applications are hereby incorporated by reference herein.

### FIELD

Embodiments of the present invention relate to a depolarization compensator to at least partially compensate for a location-dependent variation of the polarization of a laser beam.

### BACKGROUND

The depolarization compensator is used to compensate for or balance out a spatial depolarization of laser radiation, more precisely a laser beam. Depolarization is understood here as a state in which the laser beam has a well-defined but nonhomogeneous polarization (e.g., linear, circular, or elliptical) in an (arbitrary) plane perpendicular to the propagation direction of the laser beam, but rather a location-dependent variation or change in the polarization or polarization state occurs across the beam cross section of the laser beam (spatially inhomogeneous polarization). With such spatially inhomogeneous polarization, for example, circular polarization can occur in the center of the beam cross section and elliptical polarization can occur at the edge of the beam cross section of the laser beam, or vice versa.

The depolarization or the location-dependent variation of the polarization can occur, for example, if the laser beam experiences a location-dependent phase shift between the S-polarized component and P-polarized component during its propagation at an optical element, for example, in the case of an oblique incidence of a convergent or divergent laser beam on a (coated) mirror, in the case of a stress birefringence in the tensioned material of transmissive optical units, etc.

The depolarization compensator is introduced into the beam path of the laser beam and is used to introduce a phase shift varying in a location-dependent manner into the optical system, which is ideally precisely opposite to the location-dependent variation of the phase shift due to the depolarization, i.e. has the opposite sign and the same absolute value as the phase shift due to the polarization. In the ideal case, in this way the depolarization can be exactly compensated for in an observation plane, for example at the “output” of the optical system.

Using, for example, a Babinet-Soleil compensator or a Berek compensator to compensate for a spatially homogeneous phase shift is known. Matched phase plates can be used for the compensation of a location-dependent variation of the polarization. A stress birefringence can be introduced locally into a glass plate by means of an ultrashort pulsed laser for this purpose, for example.

A depolarization compensator to compensate for the depolarization of light in laser systems is described in EP 3712 664 A1. The depolarization compensator is used for location-dependent variable polarization control and for this purpose comprises a microstructured optical element having a location-dependent varying birefringence, which was manufactured from a transparent and optically isotropic material by direct inscription using an ultrashort pulsed laser. The birefringence varying in a location-dependent manner comes into being due to differing orientation of the fast axes of birefringent nanogratings at different locations of the cross section of the microstructured optical element. The nanogratings are created during the direct inscription using the ultrashort pulsed laser in the volume of the optical element.

### SUMMARY

Embodiments of the present invention provide a depolarization compensator for at least partial compensation of a location-dependent variation of a polarization of a laser beam. The depolarization compensator includes a first compensation component comprising a birefringent material, and having a planar beam entry surface for entry of the laser beam and a beam exit surface for exit of the laser beam. A thickness of the first compensation component between the beam entry surface and the beam exit surface varies in a location-dependent manner in order to at least partially compensate for the location-dependent variation of the polarization of the laser beam. The depolarization compensator further includes a second compensation component for at least partial compensation of a light-refractive effect of the first compensation component on the laser beam. The second compensation component has no birefringent effect on the laser beam.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a schematic representation of a depolarization compensator which has a first and second compensation element made of a birefringent material according to some embodiments;

FIG. 1b shows a schematic representation analogous to FIG. 1a, in which the second compensation element is formed from a non-birefringent material according to some embodiments;

FIG. 1c shows a schematic representation analogous to FIG. 1a, in which the second compensation element has a liquid index of refraction adjustment medium according to some embodiments;

FIG. 2 shows a schematic representation of an optical system, which has a depolarizing optical component in the form of a mirror and a depolarization compensator according to some embodiments;

FIG. 3 shows a schematic representation of the phase of the S-polarized and the P-polarized component of the laser beam incident on the mirror of FIG. 2 depending on the angle of incidence according to some embodiments;

FIG. 4a and FIG. 4b show schematic representations of the location-dependent polarization of the laser beam reflected on the mirror of FIG. 2 without compensation of the depolarization (FIG. 4a) and with compensation of the depolarization (FIG. 4b), according to some embodiments;

FIG. 5 shows a schematic representation of a depolarization compensator, which has a first compensation element and a second compensation element in the form of two wedge plates according to some embodiments; and

FIG. 6a and FIG. 6b show schematic representations of a depolarization compensator, which is configured to set a wedge angle of the first compensation element and the second compensation element according to some embodiments.

### DETAILED DESCRIPTION

Embodiments of the present invention provide a depolarization compensator which is simple to produce and has the least possible influence on the propagation of the laser beam. Embodiments of the present invention also provide an optical system having such a depolarization compensator.

According to a first aspect, a depolarization compensator of the type mentioned at the outset, comprising: a first compensation component made of a birefringent material which has a preferably planar beam entry surface for the entry of the laser beam and a beam exit surface for the exit of the laser beam, wherein a thickness of the first compensation component between the beam entry surface and the beam exit surface varies in a location-dependent manner in order to at least partially, in particular completely, compensate for the location-dependent variation of the polarization of the laser beam, and a second compensation component, which at least partially, in particular completely, compensates for a light-refracting (refractive) effect of the first compensation component on the laser beam and does not have a birefringent effect on the laser beam.

In the depolarization compensator according to embodiments of the invention, the beam entry surface of the first compensation component is typically planar and is oriented perpendicularly to the beam direction of the laser beam, but this is not obligatory (see below). The thickness distribution of the first compensation component in the beam direction of the laser beam and the orientation of the optical axis of the birefringent material of the first compensation component are selected so that as the laser beam passes through the first compensation component, the entire phase shift required to compensate for the depolarization varying in a location-dependent manner is applied or generated to the greatest extent possible. The beam exit surface of the first compensation component is therefore not aligned parallel to the beam entry surface and in the general case does not have planar geometry. For the generation of a phase-shifting effect on the laser beam, the optical axis of the birefringent first compensation component, more precisely the optical axis of the birefringent material of the first compensation component, is typically aligned transversely to the beam propagation direction of the laser beam.

Since the beam exit surface is not aligned parallel to the beam entry surface, the first compensation component generates a light-refracting, refractive effect on the laser beam. To compensate for the refractive effect (“lens”) of the thickness distribution varying in a location-dependent manner of the first compensation component, the depolarization compensator has a second compensation component, which compensates for the light-refracting effect of the first compensation component on the laser beam as completely as possible and which itself does not have a birefringent effect on the laser beam. The depolarization compensator designed in this way is comparatively simple to produce and is suitable in particular for laser beams at high power.

In one embodiment, the second compensation component has a beam entry surface adjacent to the beam exit surface of the first compensation component and a planar beam exit surface, which is preferably aligned parallel to the beam entry surface of the first compensation component. In this case, the second compensation component forms a “counterpart” to the first compensation component. The beam entry surface of the second compensation component has a surface shape which corresponds to the “negative” of the surface shape of the first compensation component. The beam exit surface of the second compensation component is planar and is typically aligned parallel to the (planar) beam entry surface of the first compensation component and therefore in general perpendicularly to the beam direction of the laser beam. The index of refraction of the second compensation component is adapted to the index of refraction of the first compensation component (see below). The depolarization compensator described here therefore in the ideal case as a whole has the optical effect of a plane-parallel plate on the laser beam, which generates a defined phase shift varying in a location-dependent manner between the S-polarization and the P-polarization or between two polarization directions aligned perpendicularly to one another.

In a refinement of this embodiment, the second compensation component is formed from a birefringent material, the optical axis of which is aligned perpendicularly to the beam entry surface of the first compensation component, wherein preferably the birefringent material of the second compensation component corresponds with a birefringent material of the first compensation component. As described above, the laser beam is typically incident perpendicularly on the beam entry surface of the first compensation component, i.e. the optical axis of the birefringent material of the second compensation component is aligned parallel to the beam direction of the laser beam, which has the result that the second compensation component does not have a birefringent effect on the laser beam. As described above, to generate the phase-shifting effect, in contrast, the optical axis of the birefringent material of the first compensation component is typically aligned transversely to the beam propagation direction of the laser beam or parallel to the beam entry plane of the first compensation component.

It is in general favorable if the birefringent material of the second compensation component corresponds with the birefringent material of the first compensation component, since in this case the indices of refraction thereof correspond. The birefringent materials only differ from one another in this case in their orientation or in their intersection direction with respect to the crystallographic axes.

In an alternative embodiment, the second compensation component is formed from a non-birefringent (solid) material. In this embodiment, a material is selected for the second compensation component in which the index of refraction, more precisely the real part of the index of refraction, deviates as little as possible from the index of refraction of the birefringent material of the first compensation component at the wavelength of the laser beam. For example, the index of refraction of the non-birefringent material can correspond to the ordinary index of refraction of the birefringent material or, for example, the average value between the ordinary index of refraction and the extraordinary index of refraction of the birefringent material. The non-birefringent material can be an amorphous material or a crystalline material without birefringent effect.

In a refinement of this embodiment, the first compensation component is formed from quartz and the second compensation component is formed from quartz glass. The ordinary index of refraction of monocrystalline quartz is 1.544, the extraordinary index of refraction is 1.553 (each at a wavelength of approximately 590 nm), the index of refraction of quartz glass is in the same order of magnitude. The difference between the index of refraction of the two compensation components is therefore so small that the depolarization compensator has practically no light-refractive effect on the laser beam.

In an alternative refinement, the first compensation component is formed from sapphire and the second compensation component is formed from a non-birefringent material containing aluminum oxide. Sapphire is crystalline Al₂O₃, which has a birefringent effect. The material which contains aluminum oxide can be an amorphous material, for example ALON (aluminum oxynitride, AlN—Al₂O₃) or a crystalline material without birefringent effect, such as spinel (MgAl₂O₄). Sapphire has an ordinary index of refraction of approximately 1.768 and an extraordinary index of refraction of approximately 1.760, ALON has an index of refraction of approximately 1.79 and spinel has an index of refraction of approximately 1.719, the indices of refraction are close to one another.

In a further embodiment, the beam exit surface of the first compensation component deviates from a planar geometry and the beam entry surface of the second compensation component has a geometry complementary to the beam exit surface of the first compensation component. The beam exit surface is typically a free-form surface in this case. The thickness of the first compensation component varies irregularly across the beam cross section of the laser beam in this case. The second compensation component forms a “counterpart” to the first compensation component in this case, having a beam entry surface, the surface shape of which corresponds to the “negative” of the surface shape of the first compensation component (see above).

The following procedure can be used for the production of the above-described depolarization compensator, for example:
Determine the depolarization to be compensated or the spatially resolved phase shift to be compensated by measurement or simulation.
Select a suitable birefringent material for the first compensation component, for which a corresponding non-birefringent “pendant” exists for the second compensation component, which has the smallest possible index of refraction difference (see above) or use the same birefringent material in another “cut”, so that the optical axis extends parallel to the beam propagation direction (see above).
Computer adaptation of the thickness distribution and the axial alignment of the birefringent material of the first compensation component, so that the location-dependent variation of the phase shift is compensated for. The surface shape of the beam exit surface of the first compensation component resulting from the thickness varying in a location-dependent manner of the first compensation component defines the—complementary—surface shape of the second compensation component.

The depolarization compensator designed in the above-described manner exactly compensates, by way of the location-dependent birefringence, for the phase shift of the two polarization components, which are induced in one or more optical components having depolarizing effect, “beforehand”, in that it generates a location-dependent phase shift having opposite sign. For this purpose, the location-dependent phase shift has to be known beforehand (for example on the basis of simulations or measurements).

The thickness distribution of the first compensation component can now be adapted so that the required compensation effect occurs exactly. Depending on the “shape” and absolute value of the phase shift, the ideal surface shape of the beam exit surface of the first compensation component can be difficult to manufacture, however, even more so in consideration of the correct axial location of the optical axis of the birefringent material. It can therefore be advisable to reduce the level of complexity in the production of the depolarization compensator.

In one refinement, the beam exit surface of the first compensation component is planar and is aligned at a wedge angle in relation to the beam entry surface of the first compensation component and the beam entry surface of the second compensation component is planar and is aligned at an (identical) wedge angle in relation to the beam exit surface of the second compensation component. In this embodiment, it is presumed that the phase shift in the surroundings of a central offset that caused by the disturbance in the beam path is sufficiently linear so that a solely linear phase correction is sufficient to compensate well for the depolarization of the laser beam. In the ideal case, sufficiently good compensation can be achieved by a combination of two single-axis depolarization compensators (for example, first depolarization compensator acts only along the horizontal axis, second depolarization compensator acts only along the vertical axis). A single-axis linear correction of the phase shift can be achieved in a simple manner by a first compensation component in the form of a birefringent wedge and a corresponding non-birefringent counterpart, which also has a wedge shape.

In one refinement, the first compensation component and the second compensation component are designed for variation of the respective wedge angle. In this way, the linear compensation of the phase shift can be flexibly adapted to the respective compensation task. In this case, the depolarization compensator typically has a fixing unit in order to fix the two partial elements of the first and second compensation component relative to one another when the desired wedge angle of the respective compensation component has been set.

In one refinement of this embodiment, the first compensation component has two partial elements, which are pivotable in relation to one another for variation of the wedge angle of the first compensation component, and the second compensation component has two partial elements, which are pivotable in relation to one another for variation of the wedge angle of the second compensation component. The beam exit surface of the second partial element of the first compensation component in the beam path of the laser beam is adjacent in this case to the beam entry surface of the first partial element of the second compensation component. The rotation of the two partial elements relative to one another represents a simple option for setting the wedge angle. The two partial elements of the first compensation component are formed from a birefringent material. At least one of the two partial elements of the second compensation component is typically formed from a non-birefringent material in this case.

In one refinement, the first partial element of the first compensation component has a cylindrical beam exit surface, to which a cylindrical beam entry surface of the second partial element of the first compensation component is adjacent, and the first partial element of the second compensation component has a cylindrical beam exit surface, to which a cylindrical beam entry surface of the second partial element of the second compensation component is adjacent. The first partial element and the second partial element of the first compensation component are designed as cylinder lenses in this case, the cylinder axes of which are aligned parallel to the optical axis of the birefringence of the birefringent material of the first and the second partial element. The beam exit surface of the first partial element is concave, the beam entry surface of the second partial element is formed convex (or vice versa), the radius of curvature of the two lenses or surfaces is identical in this case. The two partial elements of the first compensation component can therefore be pivoted in relation to one another along the mutually adjacent cylindrical beam entry or beam exit surfaces. The second compensation component is also designed in the same manner.

In the above-described depolarization compensator, which compensates for a linear depolarization, in addition a spatially homogeneous phase shift component can remain, which is determined by the thickness of the depolarization compensator or the first compensation component. This spatially homogeneous phase shift component can be compensated for either by existing methods for compensation of homogeneous phase shifts (for example, Berek compensator) or, analogously to the above-described “adjustable wedge” method, an “adjustable thickness” element is implemented from the birefringent material by two displaceable wedges oriented in opposite directions (similar to a Babinet compensator).

In an alternative embodiment, a liquid index of refraction adjustment medium is introduced between the beam entry surface and the beam exit surface of the second compensation component. In this case, the “counterpart” of the first compensation component does not form a solid, but rather a liquid made of an index of refraction adjustment medium, the index of refraction of which corresponds as exactly as possible with the index of refraction of the birefringent material of the first compensation component. In particular, the entire first compensation component can be embedded or introduced into a container filled with the index of refraction adjustment medium. In this way, a lens effect does not arise due to the first compensation element, since no index of refraction differences occur transversely to the beam propagation direction of the laser beam. A mixture made of water and glycerin, for example, can be used as the index of refraction adjustment medium, wherein the index of refraction can be adjusted by the mixture proportion of the glycerin. Alternatively, an index of refraction adjustment medium adapted to the respective birefringent material can be used.

In this embodiment, the beam entry surface of the first compensation element can fundamentally deviate from a planar geometry. To avoid a light-refractive effect, in this case a beam entry surface into the container and a beam exit surface out of the container, which corresponds to the beam exit surface of the second compensation component, are typically aligned parallel to one another. For the case that the first compensation component has a planar beam exit surface, a “wedge angle” between the beam entry surface of the container and the beam exit surface of the first compensation component can be varied by a rotation of the first compensation component in the liquid of the container.

In a further embodiment, the second compensation component has a medium having an index of refraction which deviates by not more than 0.2, preferably by not more than 0.1, from the mean value of the ordinary index of refraction and the extraordinary index of refraction of the first compensation component. As described above, the medium of the second compensation component can be a solid or a liquid, the index of refraction of which is to be as close as possible to the index of refraction of the medium of the first compensation component.

According to a further aspect, an optical system comprising: a beam source for generating a laser beam, at least one optical component which generates a location-dependent variation of the polarization of the laser beam, and at least one depolarization compensator, which is designed as described above, to at least partially compensate for the location-dependent variation of the polarization of the laser beam generated by the at least one optical component.

As described above, the laser beam generated by the beam source is typically incident perpendicularly on the (planar) beam entry surface of the first compensation component of the depolarization compensator and exits perpendicularly to the (planar) beam exit surface from the depolarization compensator. The alignment of the laser beam is related in this case to the beam direction of the central beam in the center of the beam cross section of the laser beam. The depolarization compensator can in principle be arranged in the beam path before or after the optical component which generates the location-dependent variation of the polarization of the laser beam. To simplify the calculation of the required location-dependent compensation effect, it is favorable if the depolarization compensator is arranged in the collimated beam path, but this is not obligatory.

In one embodiment, the optical component which generates the depolarization forms a mirror (generally coated), on which the laser beam is incident in a convergent or divergent manner. The mirror can be a deflection mirror having a planar mirror surface, but this is not obligatory. The laser beam is generally incident obliquely in this embodiment, i.e. at an angle of incidence different from 90°, on the mirror surface of the mirror. The angles of incidence of the laser beam differ in the center and at the edge of the beam cross section due to the convergent or divergent incidence. The phase shift between the component of the laser beam polarized perpendicularly to the plane of incidence (S-polarization) and the component of the laser beam polarized parallel to the plane of incidence (P-polarization) depends on the angle of incidence of the laser beam on the mirror surface. Due to the angle dependence of the phase shift between the S-polarized and the P-polarized component of the laser beam, a phase shift results between the two polarization components which is likewise location-dependent due to the location dependence of the angle of incidence distribution. For example, a laser beam circularly polarized before the incidence on the mirror can have a polarization state which becomes elliptical toward the edge of the beam cross section after the reflection on the mirror, i.e. the polarization state becomes spatially inhomogeneous.

Perpendicularly to the plane of incidence, the angle deviation between the central beam and the edge beam of the beam cross section of the laser beam is determined only by the divergence angle of the laser beam and is therefore generally small. In the plane of incidence, the angle difference is likewise only determined by the beam divergence, however a comparatively larger central angle is achieved by the angle of incidence on the mirror surface. Since the phase shift between S-polarization and P-polarization often increases strongly with increasing angle of incidence, the phase shift in the plane of incidence is therefore comparatively large in comparison to the phase shift perpendicular to the plane of incidence.

Such a mirror therefore represents an example of an optical component which generates an essentially single-axis depolarization state when the laser beam is incident in a convergent or divergent manner on the mirror surface. A single-axis compensation of the depolarization is therefore typically sufficient in this case. If one presumes that the S to P phase shift around the central angle can be approximated in a good approximation with the aid of a linear function, then, to compensate for the resulting single-axis linear phase shift, a first compensation component can be used in the form of a single wedge plate made of birefringent material and a corresponding counterpart (see above). The precise parameters of the wedge plate(s) (wedge angle and thickness) can either be analytically calculated or determined by means of an optimization algorithm.

Further advantages of the embodiments of the invention are evident from the description and the drawing. Likewise, the features mentioned above and those that are yet to be presented may be used by themselves or as a plurality in any desired combinations.

In the following description of the drawings, identical reference numerals are used for identical or functionally identical components.

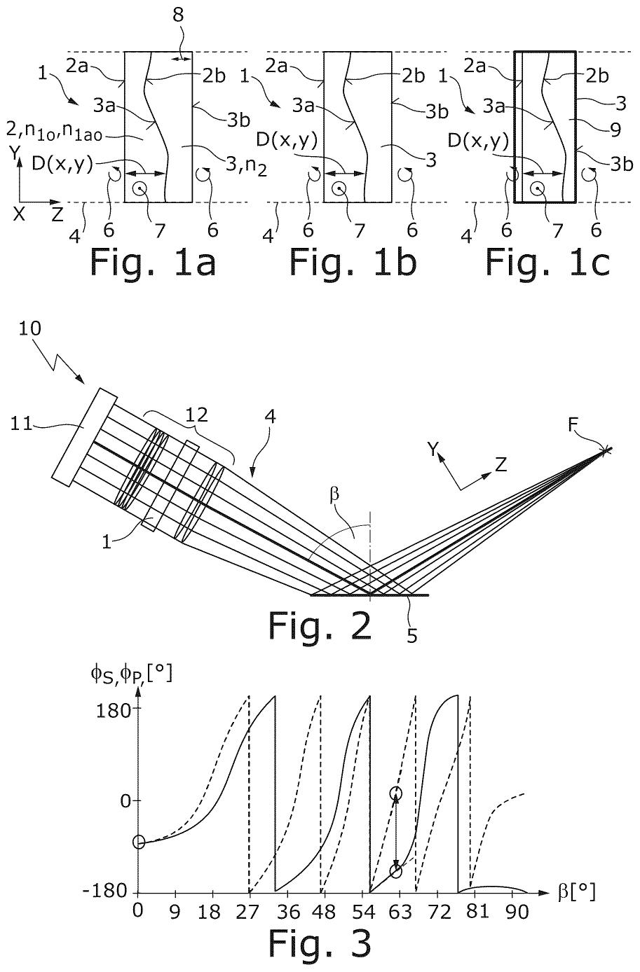

FIGS. 1a-c show three examples of a depolarization compensator 1, which has a first compensation component 2 and a second compensation component 3. The first compensation component 2 is formed in FIGS. 1a-c from a birefringent solid material, for example from quartz or sapphire. The first compensation component 2 has a planar beam entry surface 2a for the entry of a laser beam 4 and a beam exit surface 2b, designed as a free-form surface, for the exit of the laser beam 4. The laser beam 4 is incident in the example shown perpendicularly on the beam entry surface 2a of the first compensation component 2 and has a beam cross section which extends in the example shown over approximately the entire beam entry surface 2a of the first compensation component 2, but this is not obligatory. In general, the beam cross section of the laser beam 4 is rather somewhat smaller than the free aperture of the compensation component 2 (for example, half as large) to avoid diffraction effects and power loss at the edge of the optical unit. A thickness D(X, Y) of the first compensation component 2 in a direction perpendicular to the beam entry surface 2a, which corresponds to the Z direction of an XYZ coordinate system and the beam direction of the laser beam 4, varies in the example shown depending on the location X, Y both in the X direction and in the Y direction.

The laser beam 4 shown in FIGS. 1a-c was originally circularly polarized over its entire beam cross section, but has experienced a depolarization upon the reflection at an optical component, for example in the form of a mirror 5 shown in FIG. 2, and therefore no longer has a uniform, homogeneous polarization 6 over its beam cross section. The location-dependent thickness D(X, Y) of the first compensation component 2 is selected so that, at a respective location X, Y of the beam cross section of the laser beam 4, it compensates for the depolarization of the laser beam 4, i.e. the location-dependent variation of the polarization 6 of the laser beam 4, so that the laser beam 4 has a uniform polarization state over the entire beam cross section after passing through the depolarization compensator 1. In the example shown, the uniform polarization state is a circular polarization state. To generate this, the thickness D(X, Y) of the first compensation component 2 at a respective location X, Y is selected so that the birefringent medium of the first compensation component 2 generates a phase shift which has the same absolute value but the opposite sign as the phase shift to be attributed to the depolarization of the laser beam 4. In this way, for example, an elliptical polarization state 6 at a respective location X, Y of the beam cross section of the laser beam 4 before the depolarization compensator 1 can be transferred into a circular polarization state 6 after passing through the depolarization compensator 1, as indicated by way of example for a location X, Y in FIGS. 1a-c. In order to generate a phase shift upon the passage of the laser beam 4 through the first compensation component 2, an optical axis 7 of the birefringent medium of the first compensation component 2 is aligned transversely to the beam direction Z of the laser beam 4, in the example shown in the X direction.

Due to the inhomogeneous thickness D(X, Y) of the first compensation component 2, the laser beam 4 is refracted in different directions depending on the location X, Y upon the exit from the beam exit surface 2b of the first compensation component 2. To avoid the light-refractive effect of the depolarization compensator 1, it has the second compensation component 3, the beam entry surface 3a of which is directly adjacent to the beam exit surface 2b of the first compensation component 2 and has a surface shape complementary thereto. A beam exit surface 3b of the second compensation component 3 is formed planar and is aligned parallel to the planar beam entry surface 3a of the first compensation component 2. For the case that the second compensation component 3 is formed from a material, the index of refraction of which deviates only slightly from the index of refraction of the birefringent material of the first compensation component 2 or corresponds thereto, the light-refractive effect of the first compensation component 2 on the laser beam 4 can be practically completely compensated for with the aid of the second compensation component, i.e. the depolarization compensator 1 has the optical effect of a plane-parallel plate. In contrast to the first compensation component 2, the second compensation component 3 has no birefringent effect on the laser beam 4. The second compensation component 3 can in principle be designed in different ways.

In the example shown in FIG. 1a, the second compensation component 3 is formed from a birefringent material, the optical axis 8 of which is aligned perpendicularly to the beam entry surface 2a of the first compensation component 2 and therefore parallel to the beam direction Z of the laser beam 4. Due to this alignment of the optical axis 8, the second compensation component 3 has no birefringent effect on the laser beam 4. In the example shown, the first compensation component 2 and the second compensation component 3 are produced from the same birefringent material, so that the indices of refraction of the two compensation components 2, 3 essentially correspond.

In the depolarization compensator 1 shown in FIG. 1b, the second compensation component 3 is formed from a non-birefringent material, which has the smallest possible difference in index of refraction from the birefringent material of the first compensation component 2. The material of the first compensation component 2 can in this case be, for example, quartz and the material of the second compensation component 3 can be quartz glass. Alternatively, the material of the first compensation component 2 can be sapphire and the material of the second compensation component 3 can be a non-birefringent material containing aluminum oxide, such as ALON or spinel. It is obvious that other material combinations are likewise possible.

FIG. 1c shows an example of a depolarization compensator 1, in which a liquid index of refraction adjustment medium 9 is introduced between the beam entry surface 3a and the beam exit surface 3b of the second compensation component 3. In the example shown in FIG. 1c, the entire first compensation component 3 is embedded in the liquid index of refraction adjustment medium 9, the index of refraction of which is adjusted to the index of refraction of the birefringent medium of the first compensation component 2.

In general, it is favorable if the second compensation component 3 has a medium having an index of refraction n₂ which deviates by not more than 0.2, better by not more than 0.1, from the mean value (arithmetic mean) of the ordinary index of refraction n₁ₒ and the extraordinary index of refraction n₁ₐₒ of the first compensation component 2.

It will be described in more detail hereinafter on the basis of an optical system 10 shown in FIG. 2 how the depolarization of the laser beam 4 generated by a beam source 11 takes place at the mirror 5, which is designed as a planar deflection mirror. The laser beam 4 generated by the beam source 11 is focused by a focusing unit 12 in the form of an objective on a focal position F and is incident in a convergent manner on the mirror 5. An angle of incidence β of the laser beam 4 on the mirror 5 is 60° in the center of the beam cross section (“central beam”) in the example shown. However, the angle of incidence varies over the beam cross section from the center to the edge of the beam cross section (“marginal beam”) in the plane of deflection or incidence Z, Y. FIG. 3 shows the phase Φₛ of the component of the laser beam 4 polarized perpendicular to the plane of deflection Z, Y (S-polarization) and the phase Φₚ of the component of the laser beam 4 polarized parallel to the plane of deflection Z, Y (P-polarization) depending on the angle of incidence β. As can be seen in FIG. 3, at an angle of incidence of β=60°, a substantial phase shift Φₛ−Φₚ is generated between the S-polarized and the P-polarized component of the laser beam 4. However, the angle of incidence is 0° perpendicular to the plane of deflection Z, Y and the phase shift Φₛ−Φₚ is very small. As can likewise be seen in FIG. 3, the phase shift Φₛ−Φₚ in the vicinity of 60° is approximately linearly dependent on the angle of incidence β.

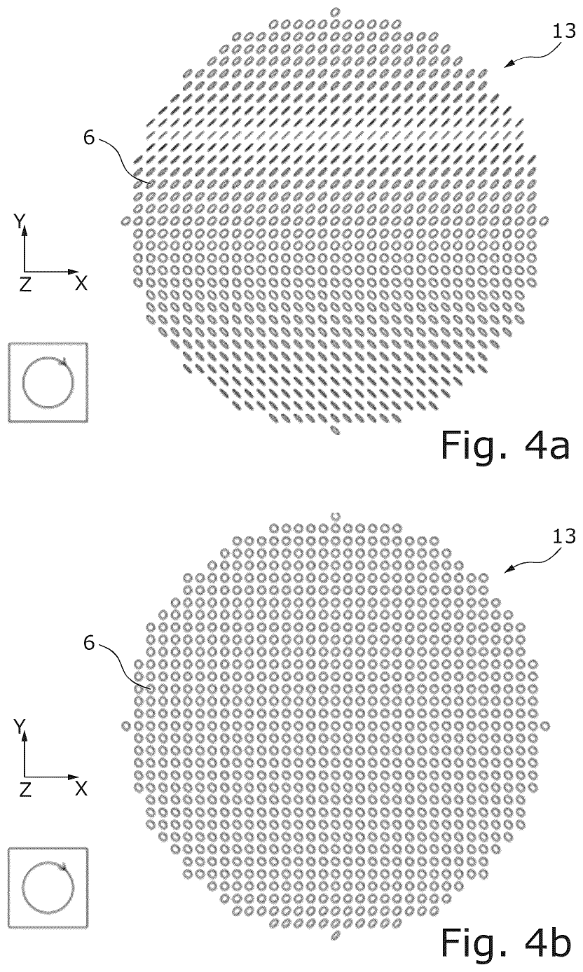

The dependence of the phase shift Φₛ−Φₚ on the angle of incidence β has the result that the polarization 6 of the initially circularly polarized laser beam 4, after the reflection on the deflection mirror 5, varies in a location-dependent manner over the beam cross section 13 of the laser beam 4 shown in FIG. 4a, wherein the resulting variation in the Y direction, i.e. in the plane of deflection Y, Z, is significantly greater than in the X direction perpendicular to the plane of deflection Y, Z. In the Y direction, the polarization state varies from circular in the center of the beam cross section through elliptical or linear to circular at the edge of the beam cross section, while only minor depolarization occurs in the X direction.

A depolarization compensator 1, which is designed as described above in conjunction with FIGS. 1a-c, can now be designed to compensate for the depolarization of the laser beam 4 shown in FIG. 4a. However, depending on the type of the depolarization, the depolarization compensator 1 shown in FIGS. 1a-c can possibly be complex to manufacture. For the case that the phase shift Φₛ−Φₚ in the surroundings of a central offset is sufficiently linear, as is the case in good approximation in FIG. 3 at an angle of incidence β of 60°, a solely linear phase correction or depolarization compensation is sufficient to compensate for the depolarization of the laser beam 4. With the depolarization described in conjunction with FIG. 2, therefore such a linear phase compensation can be applied. The phase correction can moreover be single-axis, i.e. using a single linear depolarization compensator 1, since no significant depolarization occurs in the X direction, as described above. A depolarization compensator 1 for linear compensation of the depolarization shown in FIG. 4a is shown in FIG. 5.

The depolarization compensator 1 of FIG. 5 is constructed like the depolarization compensator 1 shown in FIG. 1a, i.e. the first compensation component 2 and the second compensation component 3 are produced from the same birefringent material. The depolarization compensator 1 of FIG. 5 differs from the depolarization compensator 1 of FIG. 1a in that the beam exit surface 2b of the first compensation component 2 and the beam entry surface 3a of the second compensation component 3 adjacent thereto are formed planar. The beam exit surface 2b of the first compensation component 2 is aligned at a wedge angle α in relation to the beam entry surface 2a of the first compensation component 2 and the beam entry surface 3a of the second compensation component 3 is aligned at an identical wedge angle α in relation to the beam exit surface 3b of the second compensation component 3.

The following applies for the phase Φₛ of the S-polarized component of the laser beam 4 upon the passage through the depolarization compensator 1 of FIG. 5 depending on the lateral position Y:

$${Φ}_{s} = {n}_{pol} {L}_{pol} ( y ) + {n}_{0} {L}_{unpol} ( y ) ,$$

wherein nₚₒₗ designates the extraordinary index of refraction of the material of the first compensation component 2 and no designates the ordinary index of refraction of the material of the second compensation component 3. Lₚₒₗ(y) designates the distance which the laser beam 4 covers in the first compensation component 2, Lᵤₙₚₒₗ(y) designates the distance which the laser beam 4 covers in the second compensation component 3. The distance Lₚₒₗ(y) or Lᵤₙₚₒₗ(y) varies in the Y direction, as can be seen on the basis of the dashed and the dot-dash arrow in FIG. 5.

If the half thickness of the depolarization compensator 1 is designated by L_{C}, the following applies:

$${L}_{pol} ( y ) = {L}_{c} - y tan ( α )$$

$${L}_{unpol} ( y ) = {L}_{c} + y tan ( α )$$

The following results for the phase Φₚ of the P-polarized component of the laser beam 4:

$${Φ}_{p} = 2 {n}_{0} {L}_{c} ,$$

since the P-polarized component of the laser beam 4 “sees” the ordinary index of refraction no during the propagation through the first compensation component 2 and the second compensation component 3. The following results for the phase difference Φₛ₋ₚ=Φₛ−Φₚ:

$${Φ}_{s - p} = {L}_{c} ( {n}_{pol} - {n}_{0} ) + y tan ( α ) ( {n}_{0} - {n}_{pol} ) .$$

The phase shift Φₛ₋ₚ generated by the depolarization compensator 1 shown in FIG. 5 therefore depends linearly on the Y coordinate.

Accordingly, the linear depolarization of the laser beam 4 in the Y direction shown in FIG. 4a can be essentially compensated for using the depolarization compensator 1 from FIG. 5, as shown in FIG. 4b, which shows the beam cross section of the laser beam 4 after the passage through the depolarization compensator 1 of FIG. 5. For the example shown, a numerical optimization has resulted in an optimum wedge angle α of 0.358° and an optimum center thickness L_{C} of the depolarization compensator 1 of 4.8 mm, wherein sapphire was used as the birefringent material of the two compensation components 2, 3.

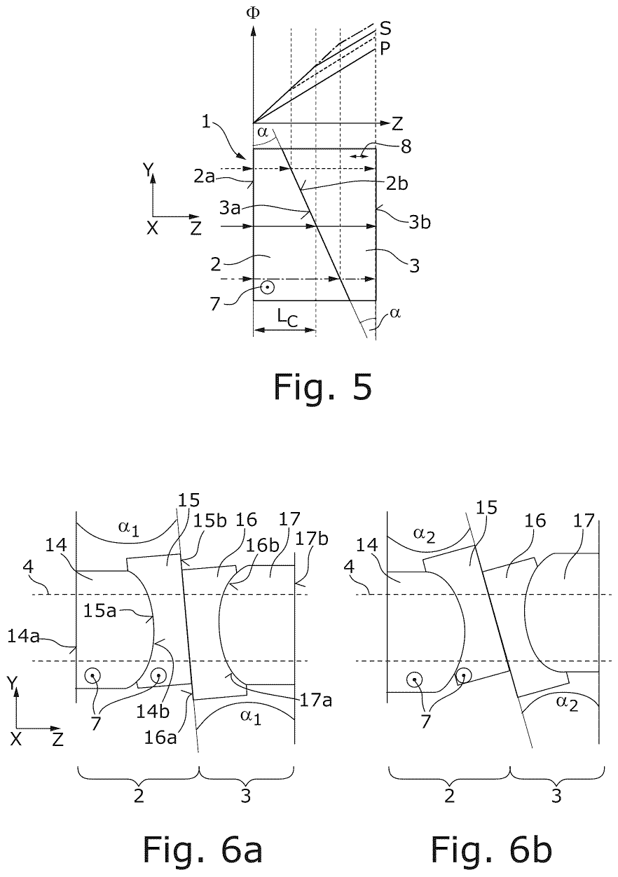

FIGS. 6a, b show a depolarization compensator 1 in which the first compensation component 2 and the second compensation component 3 are designed for variation of their respective wedge angle α₁, α₂, wherein FIG. 6a shows the two compensation components 2, 3 having a first wedge angle α₁ and FIG. 6b shows the two compensation components 2, 3 having a second wedge angle α₂. As can be seen in FIGS. 6a, b, the first compensation component 2 has two partial elements 14, 15 in the form of two cylinder lenses, which are pivotable in relation to one another for variation of the wedge angle α₁, α₂ of the first compensation component 2. The second compensation component 3 has two partial elements 16, 17 in the form of two cylinder lenses, which are pivotable in relation to one another for variation of the wedge angle α₁, α₂ of the second compensation component 3.

The first partial element 14 of the first compensation component 2 has a planar beam entry surface 14a and a cylindrical, convexly curved beam exit surface 14b, to which a cylindrical, concavely curved beam entry surface 15a of the second partial element 15 of the first compensation component 2 is adjacent, which has the same radius of curvature as the beam exit surface 14b of the first partial element 14. A planar beam exit surface 15b of the second partial element 15 of the first compensation component 2 is adjacent to a planar beam entry surface 16a of the first partial element 16 of the second compensation component 3. Accordingly, a concavely curved beam exit surface 16b of the first partial element 16 of the second compensation component 3 is adjacent to a convexly curved beam entry surface 17a of the second partial element 17 of the second compensation component 3, which has the same radius of curvature as the beam exit surface 16b of the first partial element 16. A beam exit surface 17b of the second partial element 17 of the second compensation component 3 is planar and aligned parallel to the beam entry surface 14a of the first partial element 14 of the first compensation component 3.

The first partial element 14 of the first compensation component 2 and the second partial element 17 of the second compensation component 3 are linearly displaceable relative to one another in the Y direction, the second partial element 15 of the first compensation component 2 and the first partial element 16 of the second compensation component 3 can be pivoted in relation to one another along the mutually adjacent cylindrical beam exit or beam entry surfaces 14b, 15a or 16b, 17a in order to set the respective wedge angle α₁, α₂. As can also be seen in FIGS. 6a, b, the two partial elements 14, 15 of the first compensation component 2 are formed from the same birefringent material, while the two partial elements 16, 17 of the second compensation component 3 are formed from the same non-birefringent material.

For the case that with the linear compensation of the depolarization described in conjunction with FIG. 5 and FIGS. 6a, b, a homogeneous phase shift component not varying in a location-dependent manner remains, which is determined by the thickness of the depolarization compensator 1 or the first compensation component 2, this can either be compensated for by existing methods for the compensation of homogeneous phase shifts (such as Berek compensator), or, analogously to the above-described “adjustable wedge” method, an “adjustable thickness” element made of the birefringent material is implemented by two displaceable wedges oriented in opposite directions (similarly to a Babinet compensator).

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A depolarization compensator for at least partial compensation of a location-dependent variation of a polarization of a laser beam, the depolarization compensator comprising:
a first compensation component comprising a birefringent material, having a planar beam entry surface for entry of the laser beam and a beam exit surface for exit of the laser beam, wherein a thickness of the first compensation component between the beam entry surface and the beam exit surface varies in a location-dependent manner in order to at least partially compensate for the location-dependent variation of the polarization of the laser beam, and
a second compensation component for at least partial compensation of a light-refractive effect of the first compensation component on the laser beam, the second compensation component having no birefringent effect on the laser beam.

2. The depolarization compensator as claimed in claim 1, wherein the second compensation component has a beam entry surface adjacent to the beam exit surface of the first compensation component, and a planar beam exit surface aligned parallel to the beam entry surface of the first compensation component.

3. The depolarization compensator as claimed in claim 2, wherein the second compensation component comprises a second birefringent material, and an optical axis of the second compensation component is aligned perpendicularly to the beam entry surface of the first compensation component.

4. The depolarization compensator as claimed in claim 3, wherein the second birefringent material of the second compensation component corresponds with the birefringent material of the first compensation component.

5. The depolarization compensator as claimed in claim 2, wherein the second compensation component comprises a non-birefringent material.

6. The depolarization compensator as claimed in claim 5, wherein the first compensation component comprises quartz crystal, and the second compensation component comprises quartz glass.

7. The depolarization compensator as claimed in claim 5, wherein the first compensation component comprises sapphire, and the second compensation component comprises a non-birefringent material containing aluminum oxide.

8. The depolarization compensator as claimed in claim 2, wherein the beam exit surface of the first compensation component deviates from a planar geometry, and the beam entry surface of the second compensation component has a geometry complementary to the beam exit surface of the first compensation component.

9. The depolarization compensator as claimed in claim 2, wherein the beam exit surface of the first compensation component is planar and is aligned at a first wedge angle in relation to the beam entry surface of the first compensation component, and wherein the beam entry surface of the second compensation component is planar and is aligned at a second wedge angle in relation to the beam exit surface of the second compensation component.

10. The depolarization compensator as claimed in claim 9, wherein the first compensation component and the second compensation component are configured for variation of the first wedge angle and the second wedge angle.

11. The depolarization compensator as claimed in claim 10, wherein the first compensation component comprises a first pair of elements that are pivotable in relation to one another for variation of the first wedge angle of the first compensation component, and the second compensation component comprises a second pair of elements that are pivotable in relation to one another for variation of the second wedge angle of the second compensation component.

12. The depolarization compensator as claimed in claim 11, wherein a first element of the first pair of elements has a cylindrical beam exit surface, and a second element of the first pair of elements has a cylindrical beam entry surface adjacent to the cylindrical beam exit surface of the first element of the first pair of elements, and wherein a first element of the second pair of elements has a cylindrical beam exit surface, and a second element of the second pair of elements has a cylindrical beam entry surface adjacent to the cylindrical beam exit surface of the first element of the second pair of elements.

13. The depolarization compensator as claimed in claim 2, wherein a liquid medium for index of refraction adjustment is introduced between the beam entry surface and the beam exit surface of the second compensation component.

14. The depolarization compensator as claimed in claim 1, wherein the second compensation component comprises a medium having an index of refraction that deviates by not more than 0.2 from a mean value of an ordinary index of refraction and an extraordinary index of refraction of the first compensation component.

15. An optical system, comprising:
a beam source for generating a laser beam,
at least one optical component for generating a location-dependent variation of a polarization of the laser beam, and
at least one depolarization compensator as claimed in claim 1 for at least partial compensation for the location-dependent variation of the polarization of the laser beam generated by the at least one optical component.

16. The optical system as claimed in claim 15, wherein the at least one optical component comprises a mirror, on which the laser beam is incident in a convergent or divergent manner.
